(19) United States
(12) Patent Application Publication
(10) Pub. No.: US 2025/0389848 A1
(43) Pub. Date: Dec. 25, 2025

(54) PROCESSING CIRCUIT, DTOF RECEIVER, AND PROCESSING METHOD FOR GENERATING DEPTH IMAGE

(71) Applicant: Taiwan Semiconductor Manufacturing Company, Ltd., Hsinchu (TW)

(72) Inventors: Meng-Hsiu Wu, Hsinchu (TW); Shang-Fu Yeh, Hsinchu City (TW); Hung-Yi Tu, Hsinchu City (TW); Chiao-Yi Huang, Hsinchu County (TW)

(73) Assignee: Taiwan Semiconductor Manufacturing Company, Ltd., Hsinchu (TW)

(21) Appl. No.: 18/751,325

(22) Filed: Jun. 23, 2024

(51) Int. Cl. G01S 17/894; G01S 7/4863; G01S 17/42

(52) U.S. Cl. CPC G01S 17/894; G01S 7/4863; G01S 17/42

(57) ABSTRACT

Processing circuits, DTOF receivers, and processing methods for generating depth image are provided. The processing circuit is configured to receive a first pixel information from a first single photon avalanche diode (SPAD) of a SPAD array; generate a first reflection histogram of photon count with respect to distance according to the first pixel information; rotate the first reflection histogram by a first angle; and determine a first depth according to a first peak of the rotated first reflection histogram.

### BACKGROUND

As technologies such as light detection and ranging (LiDAR), virtual reality (VR), augmented reality (AR), etc. developed, accuracy requirements to depth images have grown rapidly, since the depth image becomes a critical issue for safety concerns or for providing immersive experience to the users.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a depth image sensing system 1 that measures a distance D1 from a direct time-of-flight (DTOF) sensor to a 3D object in accordance with some embodiments of the present disclosure.

FIGS. 2A and 2B illustrate reflection histograms plotted using reflection signals, RS2 received by the DTOF sensor in accordance with some embodiments of the present disclosure.

FIG. 3 illustrates a DTOF receiver in accordance with some embodiments of the present disclosure.

FIGS. 4A-4F illustrate a process performed by the processing circuit on a reflection histogram to determine a corresponding distance in accordance with some embodiments of the present disclosure.

FIGS. 5A, 5B illustrate depth images obtained respectively using an original reflection histogram, and a reflection histogram being converted and rotated in accordance with some embodiments of the present disclosure.

FIGS. 6A-6F illustrate how a first block angle of a first pixel block is determined according to some embodiments of the present disclosure.

FIG. 7 illustrate a flowchart of a processing method in accordance with some embodiments of the present disclosure.

### DESCRIPTION OF THE EMBODIMENTS

The following disclosure provides many different embodiments, or examples, for

implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Time-of-Flight (TOF) is a method for measuring the distance between a sensor and an object, based on the time difference between the emission of a signal and its return to the sensor after being reflected by an object. That is, TOF is able to realize depth sensing, which is also known as range sensing. TOF sensors are highly advanced light detection and ranging (LiDAR) devices which replace the standard point-by-point scanning laser beams with a single light pulse to achieve full spatial awareness. TOF measurement of a ray of light generated by a mono-chromatic or wide-spectral light source can be also used in various applications, such as 3D imaging. For example, TOF sensors can be implemented to track facial or hand movements, map out a room and navigate a self-driving vehicle, etc.

TOF measurement is based on a detection of a light which is reflected by the target from a light source to a detector. There exist at least two techniques to measure the TOF: a direct method and an indirect method. In the direct method, the time difference between a START pulse, synchronized with the light source, and a STOP signal generated by the detector is evaluated. In the indirect method, a continuous sinusoidal light wave is emitted, and the phase difference between outgoing and incoming signals is measured and used to determine the time difference using a predefined algorithm.

It is noted that, a TOF sensor may utilize time-correlated single photon counting (TCSPC) methodology to achieve a high precision rate of depth sensing of the target. However, the TOF sensor utilizing the TCSPC methodology may not be able to provide a grayscale image of the target. On the other hand, an image sensor may be able to provide a grayscale image of the target. However, the image sensor is not able to provide depth information of the target.

A single-photon avalanche diode (SPAD) is a solid-state photodetector, in which, through an internal photoelectric effect, a photon-generated carrier can trigger a short-duration but relatively large avalanche current. That is, when a photon is received, avalanche current indicating the detection is generated. This avalanche current is created through a mechanism called impact ionization, in which, electrons and/or holes, as carriers, are accelerated to high kinetic energies through a large potential gradient. If the kinetic energy of a received electron, or a hole, is large enough (as a function of the ionization energy of the bulk material), additional carriers (electrons and/or holes) are liberated from the atomic lattice. As a result, the number of carriers increases exponentially from as few as a single carrier to create the avalanche current. SPAD is capable of detecting different types of low-intensity ionizing radiation, including: gamma, X-ray, beta, and alpha-particle radiation along with electromagnetic signals in the UV, Visible and IR down to the single photon level. SPADs are also capable of distinguishing the arrival times of events (photons) at high accuracy with a timing jitter of only a few tens of picoseconds. SPADs have recently been implemented in LiDAR, TOF 3D Imaging, positron emission tomography (PET) scanning, single-photon experimentation, fluorescence lifetime microscopy and optical communications, particularly quantum key distribution.

For example, a SPAD may be integrated with a pulse laser to achieve depth sensing utilizing the TSCPS methodology and a SPAD may be integrated with a continuous light source to achieve image sensing utilizing a sensitivity-boosting technique. However, since the depth sensing and the image sensing of the SPAD require different kind of light sources, the depth sensing and the image sensing of the SPAD cannot be performed at the same time. Further, both of the depth sensing and the image sensing of the SPAD require large amount of data or long integration time. That is, the depth sensing and the image sensing of the SPAD may need to be performed separately, which increases the processing time and decreases the performance of the whole system. Therefore, how to develop a convenient and effective method to perform both the depth sensing and the image sensing is becoming an issue to work on.

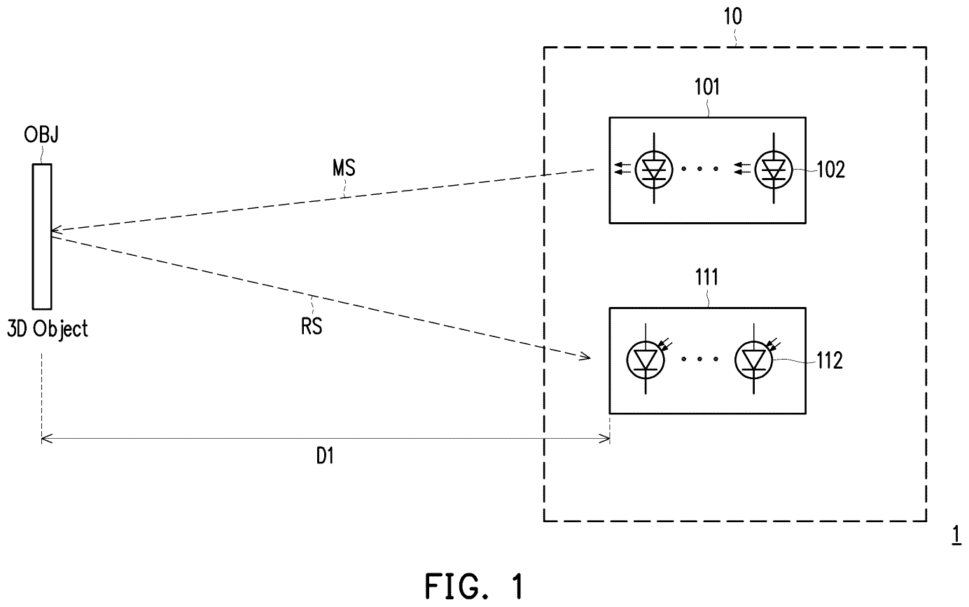

FIG. 1 illustrates a depth image sensing system 1 that measures a distance D1 from a direct time-of-flight (DTOF) sensor 10 to a 3D object OBJ in accordance with some embodiments.

In one embodiment, a light source 101 is configured to emit a modulated signal MS toward the 3D object OBJ. In some embodiment, the light source 101 may include an array of Light-Emitting Diodes (LEDs) or solid-state lasers 102 such as Vertical-Cavity Surface-Emitting Lasers (VCSEL) with wavelengths in the range of 850 nanometers (nm)-870 nm. In some embodiments, the modulated signal MS may be a square wave or a continuous-wave such as a sinusoid. In some embodiments, the modulated signal MS may be periodically generated with a predetermined periodicity. In another embodiment, the modulated signal MS may be generated using digital circuitry including ring oscillators and counters.

A reflected signal RS is reflected from the 3D object OBJ and detected by a DTOF receiver 111. In some embodiments, the DTOF receiver 111 may include a 2-dimensional light sensing array 112. In some embodiment, the DTOF receiver 111 may be implemented by single photon avalanche diode (SPAD) light receivers. As illustrated in FIG. 1, the DTOF sensor 10 operates by measuring a roundtrip travel time of photons emitted from the light source 101 and captured by the DTOF receiver 111. The roundtrip travel time of photons carried in the modulated signal MS and the reflected signal RS is determined by measuring the phase delay of the reflected signal RS from the modulated signal MS. The distance D is then determined by

$$D = \frac{1}{2} c {T}_{d} ,$$

where c is the speed of light in a material medium in which the 3D object OBJ and the DTOF sensor 10 are located, and T_{d} is the roundtrip travel time of photons emitted from the light source 101 and captured by the DTOF receiver 111.

By arranging the SPAD light receivers in an array, each SPAD light receiver may be configured to capture light reflected from a predetermined area on the 3D object OBJ to generate a corresponding depth information. Each depth information may be analyzed to obtain a depth of the corresponding area on the 3D object OBJ and thus all the depth information gathered together may be used to construct a depth image of the 3D object OBJ.

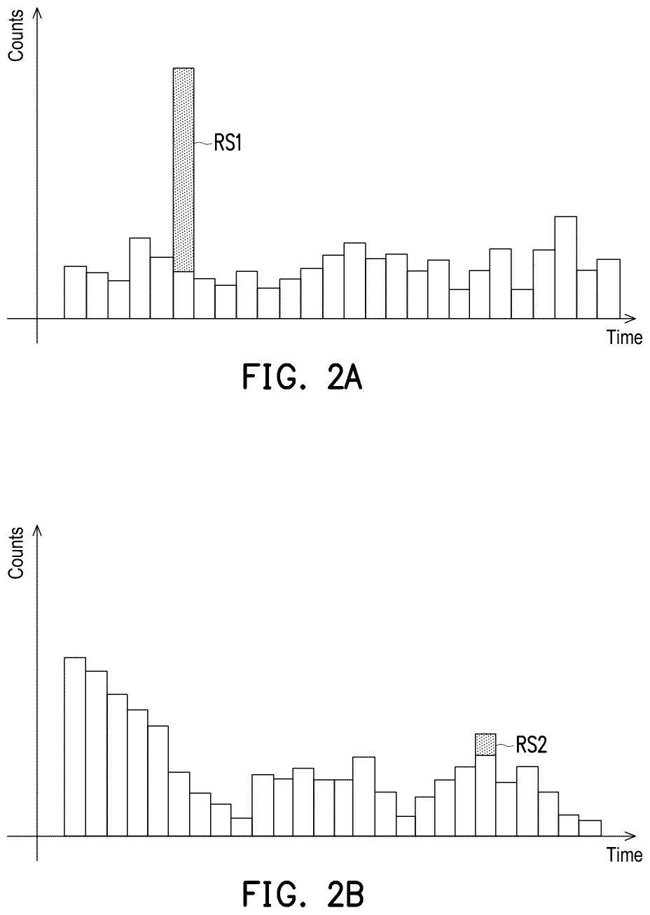

FIGS. 2A and 2B illustrate reflection histograms plotted using reflection signals RS1, RS2 received by the DTOF sensor 10 in accordance with some embodiments of the present disclosure. Specifically, in FIGS. 2A and 2B, a vertical axis and a horizontal axis respectively correspond to received photon counts and received time.

In FIG. 2A, the reflection histogram records a relationship between received photon counts in time of the reflection signal RS1. The reflection histogram in FIG. 2A includes background noise plotted in white boxes and a peak count plotted in a gray box. In this embodiment, the 3D object reflecting the reflection signal RS1 is placed at a place closer to the DTOF sensor 10, so the reflection signal RS1 has a higher count in the histogram. As can be seen in FIG. 2A, a peak with a maximum count corresponds to the received reflection signal RS1 stands out from the background noise in the histogram, and the peak with the maximum count in the histogram makes it easier for the DTOF sensor 10 to tell the roundtrip travel time of the reflection signal RS1.

In FIG. 2B, the reflection histogram records a relationship between received photon counts in time of the reflection signal RS2. In this embodiment, the 3D object reflecting the reflection signal RS2 is placed at a place further away from the DTOF sensor 10. With the 3D object OBJ placed further away, the reflected photon count corresponding to the reflection intensity dropped lower, so the reflection signal RS2 has a lower count in the histogram compared to the peak in FIG. 2A. As can be seen in FIG. 2B, a peak corresponding to the received reflection signal RS2 is almost buried in the background noise in the histogram, making it harder for the DTOF sensor 10 to tell the roundtrip travel time of the reflection signal RS2.

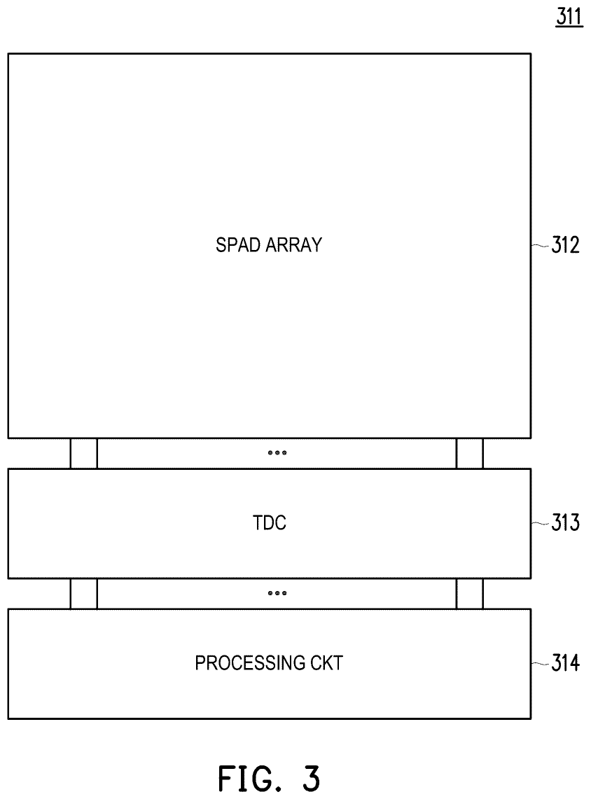

FIG. 3 illustrates a DTOF receiver 311 in accordance with some embodiments of the present disclosure. The DTOF receiver 311 includes a SPAD array 312, a time-to-digital converter (TDC) 313, and a processing circuit 314.

The SPAD array 312 comprises a plurality of SPADs arranged in rows and columns. Each SPAD is configured to receive a corresponding reflection signal reflected from a predetermined angle to generate a corresponding pixel information, so all of the pixel information may be put together to construct a depth image. Each pixel information records a relationship between a photon count received over time. The TDC 313 is configured to transform each pixel information from a time-based data to a distance-based data. In some aspect, the TDC 313 is configured to convert the reception time of the reflection signal of the reflection signal according to the speed of light, so the converted pixel information records the relationship between the photon count over the reflected distance.

Further, the processing circuit 314 is configured to receive a first pixel information from the TDC 313; generate a first reflection histogram of photon count with respect to distance according to the first pixel information; rotate the first reflection histogram by a first angle; determine a first depth according to a first peak of the rotated first reflection histogram. Details regarding operations of the processing circuit 314 will be described in paragraphs below.

Examples of the processing circuit 314 include, but are not limited to, a central processing unit (CPU), a microprocessor, an application specific integrated circuit (ASIC), a graphics processing unit (GPU), a field programmable gate array (FPGA), an advanced RISC machine (ARM) processor or combinations thereof. In addition, the processing circuit 314 may also be implemented through synthesis using hardware description language (HDL), such as high-speed hardware description language (VHDL), Verilog or the like.

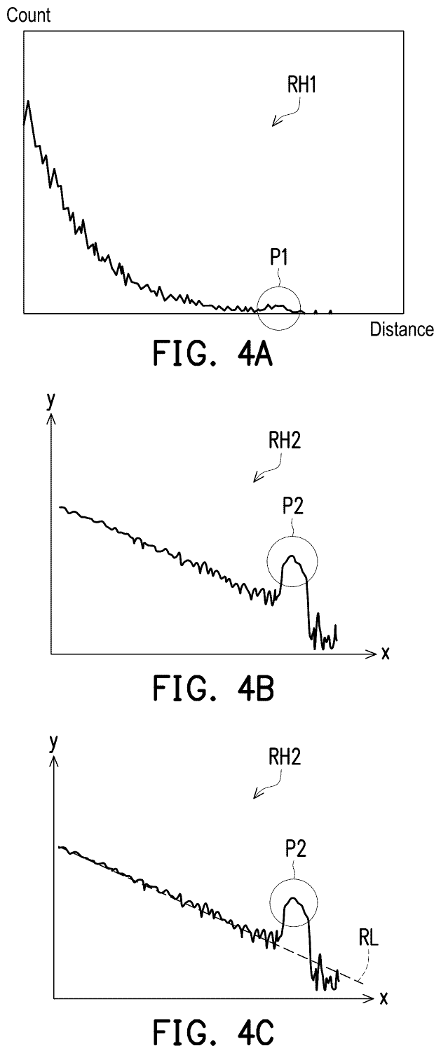

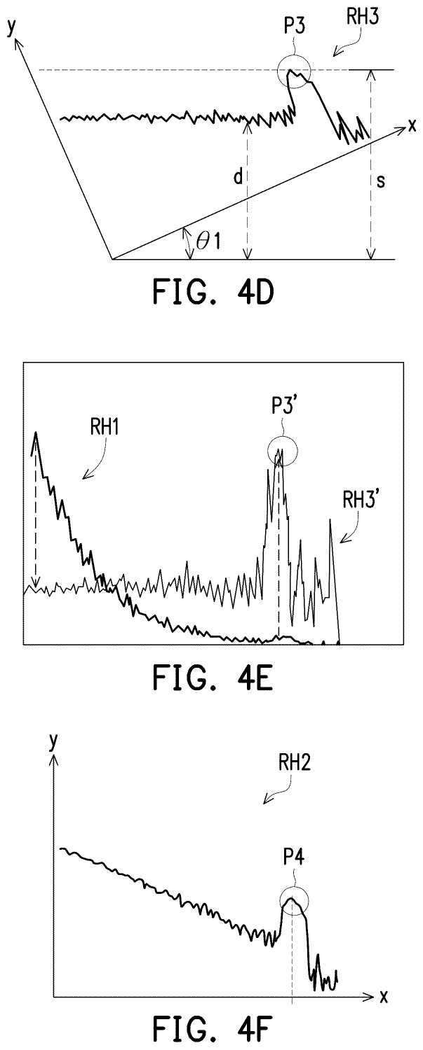

FIGS. 4A-4D illustrate a process performed by the processing circuit 314 on a reflection histogram to determine a corresponding distance in accordance with some embodiments of the present disclosure. Specifically, a first SPAD in the SPAD array 312 is configured to sense incident photons and provide a first pixel information accordingly. The TDC 313 is configured to convert a reception time in the first pixel information into a reflected distance. The TDC 313 may be configured to continuously convert the first pixel information and provide the converted first pixel information to the processing circuit 314, so the processing circuit 314 may accordingly record a relationship between the photon count and the corresponding distance, which forms the first reflection histogram.

In FIG. 4A, the processing circuit 314 is configured to generate a first reflection histogram RH1 according to the first pixel information with a vertical axis corresponds to a photon count and a horizontal axis corresponds to a distance. As can be seen in FIG. 4A, the first reflection histogram RH1 records a noise distribution with the received photon counts decay over distance. The noise distribution as depicted in FIG. 4A has a relatively large photon count value in the beginning and then decays quickly as the reception time increased. Due to the relatively large photon count in the noise distribution, a peak P1, corresponding to the time when the reflection signal RS is received, is embedded in the noise distribution and hard to be discerned.

In some embodiments, the noise distribution in the first reflection histogram RH1 can be modeled and represented by the following equation

$$Y = \frac{1}{τ} {e}^{- t / τ} ,$$

where Y is the photon count being distributed with the Poisson probability density function, τ is the time constant of interval time, t is the received interval time. The photo count could be total captured number multiplied by Poisson probability function. As can be observed in the equation, the photon count exponentially decays over time.

In FIG. 4B, the processing circuit 314 is configured to transform the first reflection histogram RH1 using a first transformation function to generate a transformed first reflection histogram RH2. In some embodiments, in order to transform the noise distribution from an exponential function to a linear function, the processing circuit 314 is configured to use a logarithm function as the first transformation function, and bring the photon counts into the logarithm function to produce the transformed first reflection histogram RH2. Particularly, after the logarithm conversion, the noise distribution in the transformed first reflection histogram RH2 may be represented by the following equation:

$${Y}^{′} = - t / τ + ln 1 / τ ,$$

where Y′ is the first derivative (i.e., probability) of the photon count over time. The photon count could be total capture multiplied by the probability. According to the equation above, the transformed noise distribution may be approximated and represented by a linear function in the transformed first reflection histogram RH2. As can be seen in FIG. 4B, since the noise distribution is converted from the exponential function to the linear function, the relatively large number of photons in the noise distribution near the origin in FIG. 4A is compressed in FIG. 4B, making a peak P2 converted from the peak P1 more expressed in FIG. 4B.

In FIG. 4C, the processing circuit 314 is configured to determine a regression line RL of the converted first reflection histogram RH2. The regression line RL may be generally corresponded to the linear model of the noise distribution in the converted first reflection histogram RH2, so a first slope of the regression line RL may be approximated to −1/τ as expressed in the equation above.

In FIG. 4D, the processing circuit 314 is configured to rotate the converted first reflection histogram RH2 by a first angle θ1. More particularly, the first angle θ1 used to rotate the converted first reflection histogram RH2 may be obtained from the first slope of the regression line RL obtained in FIG. 4C. Specifically, it is known that a slope of a line will be the same as taking a tangent function to an inclination angle of the same line. In this way, the first angle θ1 may be obtained by taking an arctangent function to the first slope of the regression line RL in FIG. 4C. Further, to produce the rotated first reflection histogram RH3, each point in FIG. 4C may be rotated by the following equation:

$$[ \begin{matrix}{x}^{′} \\ {y}^{′}\end{matrix} ] = [ \begin{matrix}cos θ1 & - sin θ1 \\ sin θ1 & cos θ1\end{matrix} ] \cdot [ \begin{matrix}x \\ y\end{matrix} ] ,$$

where x and y are coordinates of each point, and x′ and y′ are coordinates of each point after rotation. Specifically, the coordinate of each point may be multiplied by the rotation matrix to rotate by a counterclockwise angle θ1.

In the rotated first reflection histogram RH3, since the noise distribution is now flat and evenly distributed at the bottom in FIG. 4D, it becomes easier for the processing circuit 314 to locate a peak P3 rotated from the peak P2. Specifically, the processing circuit 413 is configured to compare and find a maximum value in the rotated first reflection histogram RH3 and take the maximum value as the peak P3.

In some embodiments, scaling and shifting operations may be added in the rotation operation. For example, each point in FIG. 4C may be rotated by the following equation:

$$[ \begin{matrix}{x}^{′} \\ {y}^{′}\end{matrix} ] = [ \begin{matrix}1 & 0 \\ 0 & s\end{matrix} ] \cdot ( [ \begin{matrix}cos θ1 & - sin θ1 \\ sin θ1 & cos θ1\end{matrix} ] \cdot [ \begin{matrix}x \\ y\end{matrix} ] + [ \begin{matrix}0 \\ - d\end{matrix} ] ) ,$$

where s is a scale factor and d is a shift distance. In some embodiments, the shift distance d may be a distance between the rotated regression line and the vertical axis, and the scale factor s may be a factor for normalizing the amplitude of the peak P3. The equation above includes a shift matrix and a scale matrix. The rotated coordinates are shifted down by the shift distance d to cancel the offset of the rotated regression line, and then multiplied by the scale factor s to normalize the magnitude of the peak P3. In this way, it may be easier for the processing circuit 314 to determine the peak P3 from the rotated first reflection histogram RH3.

FIG. 4E illustrates a comparison between the reflection histograms RH1 and RH3′ in accordance with some embodiments of the present disclosure. In this embodiment, the scale and shifting operations have been performed and the histograms RH3′ with a better signal-to-noise ratio (SNR) is generated. Specifically, as can be seen in FIG. 4E, the peak P3′ has a better large amplitude while maintaining a relatively low noise level, benefitting image quality of the generated depth image.

In FIG. 4F, in order to tell the correct distance corresponding to the peak P3, the processing circuit 314 is configured to reversely rotate the coordinate of the peak P3 by the first angle to output a peak P4. The reverse rotation to the coordinate of the peak P3 may be represented by the following equation:

$$[ \begin{matrix}{x}^{″} \\ {y}^{″}\end{matrix} ] = [ \begin{matrix}cos ( - θ1 ) & - sin ( - θ1 ) \\ sin ( - θ1 ) & cos ( - θ1 )\end{matrix} ] \cdot [ \begin{matrix}{x}^{′} \\ {y}^{′}\end{matrix} ] ,$$

where x″ and y″ are the coordinates of a peak P4 in the first reflection histogram RH2, and x′ and y′ are the coordinates of the peak P3 in the rotated first reflection histogram RH3. Specifically, the rotation matrix corresponds to rotate the peak coordinate by a clockwise angle θ1 After the reverse rotation, the statistic diagram is recovered to the first reflection histogram RH2 in FIG. 4B before rotation, and the processing circuit 314 is configured to take the y″ coordinate of the peak P4 as the first depth. Specifically, after correctly finding out the peak P3 corresponding to the first reflection signal, the reverse rotation may correctly recover the coordinate from the peak P3 to P4, for properly determining the distance corresponding to the received first reflection signal.

In some embodiment, when additional scale and shift operations are included in the rotated first reflection histogram RH3, the reverse rotation to the first reflection histogram RH3 may be required to take the scale and shift into account in order to obtain the correct distance corresponding to the first reflection signal. The reverse rotation to the coordinate of the peak P3 may be represented by the following equation:

$$[ \begin{matrix}{x}^{″} \\ {y}^{″}\end{matrix} ] = [ \begin{matrix}cos ( - θ 1 ) & - sin ( - θ 1 ) \\ sin ( - θ 1 ) & cos ( - θ 1 )\end{matrix} ] \cdot ( [ \begin{matrix}1 & 0 \\ 0 & 1 / s\end{matrix} ] \cdot [ \begin{matrix}{x}^{′} \\ {y}^{′}\end{matrix} ] + [ \begin{matrix}0 \\ d\end{matrix} ] ) ,$$

where s is the scale factor and d is the shift distance used for rotating the first reflection histogram RH2 to the first reflection histogram RH3. The above equation included a shift matrix and a scale matrix for recovering the normalized magnitude and canceled offset in the first reflection histogram RH3.

In summary, the processing circuit 314 is configured to use the first transformation function to convert the first reflection histogram RH1 to compress noise and make the peak corresponding to the first reflection signal more expressible. Further, after conversion, the noise level in the first reflection histogram is converted from exponential distribution to linear distribution. Then, rotation is performed to the converted first reflection histogram, aiming to turn the noise distribution from an oblique straight line into a horizontal straight line, so the peak corresponding to the first reflection signal may have the maximum amplitude in the rotated first reflection histogram, and is more easily to be located. At last, the peak in the rotated first reflection histogram will be reverse rotated in order to find out the correct distance where the first reflection signal is reflected from.

In some embodiments, the noise in the first reflection histogram may be distributed based on different probability functions. Under such a circumstance, the first transformation function used to compress the amplitude of the noise may be accordingly altered to adapt different noise environments.

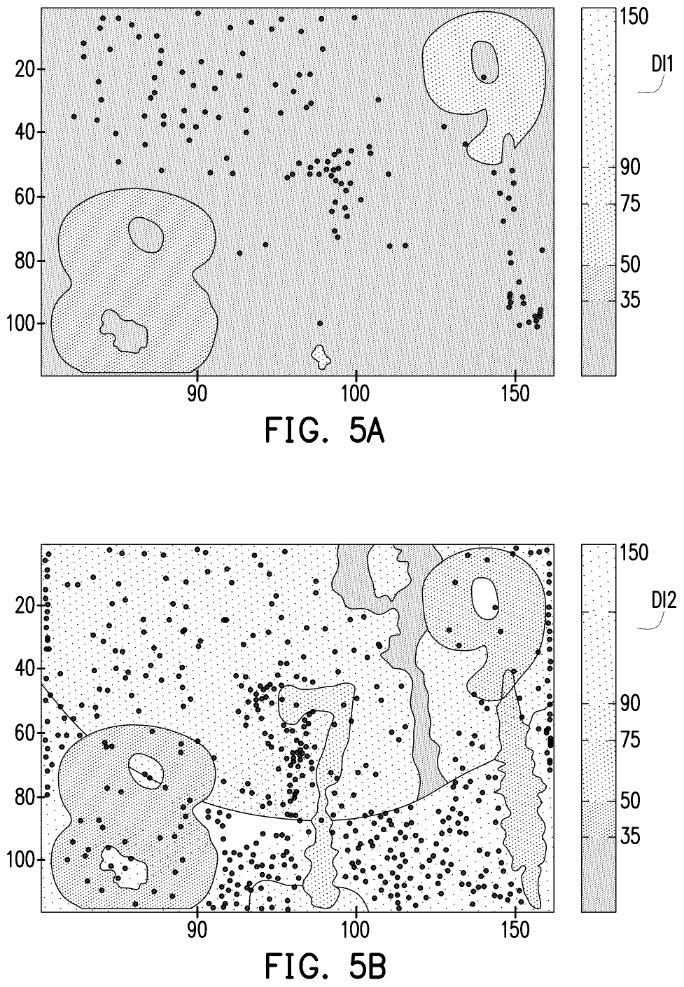

FIGS. 5A, 5B illustrate depth images DI1, DI2 obtained respectively using an original reflection histogram, and a reflection histogram being converted and rotated in accordance with some embodiments of the present disclosure.

As can be seen in FIG. 5A, as described in relation to FIG. 4A, the noise distribution is exponentially distributed and usually has a relatively large amplitude near the origin, so the depth image DI1 in FIG. 5A is apparently affected by the noise, only showing distances in short and middle ranges.

Comparing the depth images DI1, DI2, the depth image DI2 has a better view showing the sensed distance of all ranges, demonstrating that the processing circuit 314 and the DTOF receiver 311 may estimate the depth more accurately through conversing and rotation.

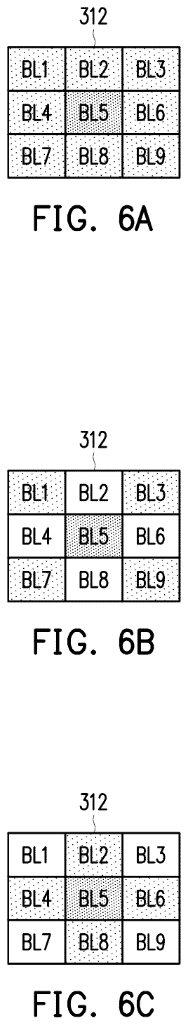

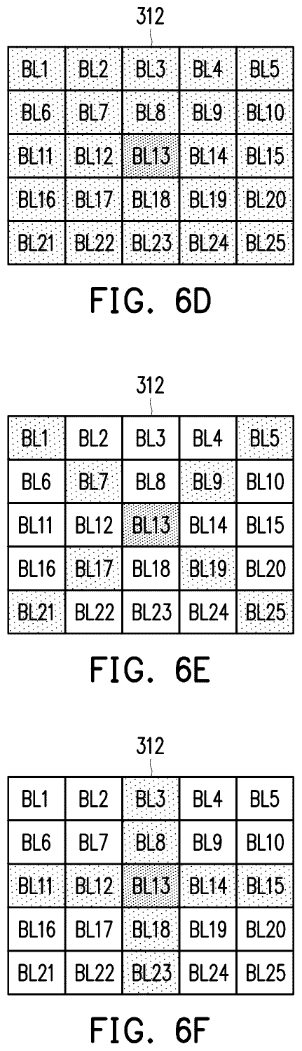

FIGS. 6A-6E illustrate how a first block angle of a first pixel block is determined according to some embodiments of the present disclosure. Specifically, in order to reduce computational complexity, the processing circuit 314 may divide the SPAD array 312 into a plurality of SPAD blocks, and apply a same rotation angle to all reflection histograms of each SPAD block. In some embodiments, the applied rotational angle may be an average angle using the first angles of a same SPAD block or different SPAD blocks.

In FIG. 6A, the SPAD array 312 is divided into 3×3 SPAD blocks BL1-BL9. Each SPAD block includes a plurality of SPADs and is configured to sense and generate a plurality of pixel information. In some embodiments, taking the SPAD block BL5 as an example, the processing circuit 314 is configured to receive a plurality of first block pixel information from a first SPAD block of the SPAD array; generate a plurality of first block reflection histograms according to the plurality of first block pixel information; rotate the plurality of first block reflection histograms by a first block angle; and determine a plurality of first block depths according to the plurality of rotated first reflection histograms. Specifically, as for the first block angle, the processing circuit 314 is configured to determine a plurality of slopes of a plurality of regression lines respectively of the plurality of first block reflection histograms; and determine the first block angle by calculating an average angle of the plurality of slopes. In short, the processing circuit 314 is configured to calculate the average angle according to the slopes of all regression lines of the first refection histograms in the SPAD block BL5, so all the first reflection histograms in the first SPAD block are rotated by the same first block angle, thereby reducing computational complexity. In some embodiments, the average angle may be one of a geometric mean, an arithmetic mean, a medium, a mode, or etc. of the first angles

In some embodiments, the processing circuit 314 is configured to determine the first block angle of the SPAD block BL5 using an average angle of all SPAD blocks within the predetermined area including the SPAD blocks adjacent to the SPAD block BL5. Specifically, after the block angles are calculated, the processing circuit 314 may be configured to determine the first block angle by calculating an average angle of all the block angles of the SPAD blocks BL1-BL9 as the updated first block angle; and rotate the plurality of first block reflection histograms within the first SPAD block BL5 by the updated first block angle. In some embodiments, the calculated average angle may be used to rotate all reflection histograms of the SPAD blocks BL1-BL9 within the predetermined area.

In some embodiments, the first block angle may be determined according to the block angles of a plurality of second SPAD blocks arranged with the first SPAD block along predetermined directions.

For example, as depicted in FIG. 6B, the first block angle of the SPAD block BL5 may be determined by the processing circuit 314 through calculating an average angle of the block angles of the SPAD blocks BL1, BL3, BL7, BL9 which are arranged on diagonal directions of the first SPAD block BL5.

In another example as depicted in FIG. 6C, the first block angle of the SPAD block BL5 may be determined by the processing circuit 314 through calculating an average angle of the block angles of the SPAD blocks BL2, BL4, BL6, BL8 which are arranged on vertical and horizontal directions of the first SPAD block BL5.

In FIG. 6D, the SPAD array 312 is divided into 5×5 SPAD blocks BL1-BL25. In such

example, the first block angle of the SPAD block BL13 may be determined by the processing circuit 314 through calculating an average angle of the block angles of all SPAD blocks BL1-BL25.

In FIG. 6E, the first block angle of the SPAD block BL13 may be determined by the processing circuit 314 through calculating an average angle of the block angles of the SPAD blocks BL1, BL5, BL7, BL9, BL17, BL19, BL21, BL25 which are arranged on diagonal directions of the first SPAD block BL5.

In FIG. 6F, the first block angle of the SPAD block BL13 may be determined by the processing circuit 314 through calculating an average angle of the block angles of the SPAD blocks BL3, BL8, BL11, BL12, BL14, BL15, BL18, BL23 which are arranged on vertical and horizontal directions of the first SPAD block BL13.

In some embodiments, the first block angle of the first SPAD block may be determined by the processing circuit 314 through calculating an average angle of the block angles of all SPAD blocks in the SPAD array 312. In other words, a global rotation angle may be determined using the average angle of all pixels in the SPAD array 311, thereby reducing computational complexity.

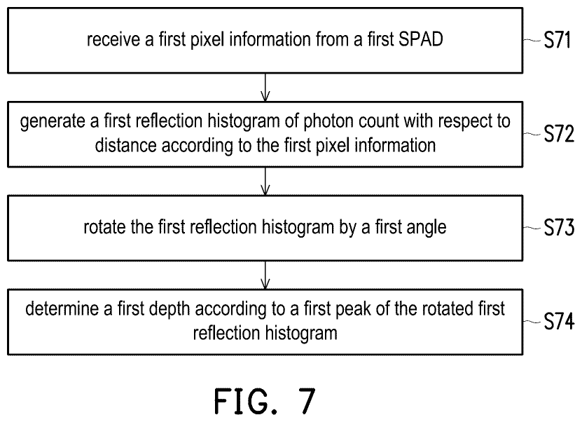

FIG. 7 illustrate a flowchart of a processing method in accordance with some embodiments of the present disclosure. The processing method in FIG. 7 may be applied to for controlling the depth image sensing system 1 in FIG. 1 and/or the DTOF receiver 311 in FIG. 3 to generate a depth image. The processing method includes steps S71-S74.

In step S71, a processing circuit may receive a first pixel information from a first SPAD in a SPAD array. In step S72, the processing circuit may generate a first reflection histogram of photon count with respect to distance according to the first pixel information. In step S73, the processing circuit may rotate the first reflection histogram by a first angle. In step S74, the processing circuit may determine a first depth according to a first peak of the rotated first reflection histogram. In some aspect, operations regarding the depth image sensing system 1 in FIG. 1 and/or the DTOF receiver 311 may be summarized in the processing method, and please refer to paragraphs above for detailed operations of the depth image sensing system 1 in FIG. 1 and/or the DTOF receiver 311, which are not omitted herein.

In some embodiments, a processing circuit, for generating a depth image, is configured to: receive a first pixel information from a first single photon avalanche diode (SPAD) of a SPAD array; generate a first reflection histogram of photon count with respect to distance according to the first pixel information; rotate the first reflection histogram by a first angle; determine a first depth according to a first peak of the rotated first reflection histogram.

In some embodiment, the processing circuit is configured to: transform the first reflection histogram using a first transformation function; and rotate the transformed first reflection histogram by the first angle.

In some embodiment, the first transform function is a logarithm function.

In some embodiment, the processing circuit is configured to calculate a first slope of a regression line within the first reflection histogram to determine the first angle.

In some embodiment, the processing circuit is configured to: determine a peak coordinate of the first peak in the rotated first reflection histogram; reversely rotate the peak coordinate by the first angle; and determine the first depth according to a time-of-flight of the reversely-rotated peak coordinate.

In some embodiment, the processing circuit is further configured to: receive a plurality of first block pixel information from a first SPAD block of the SPAD array; generate a plurality of first block reflection histograms according to the plurality of first block pixel information; rotate the plurality of first block reflection histograms by a first block angle; and determine a plurality of first block depths according to the plurality of rotated first reflection histograms.

In some embodiment, the processing circuit is configured to: determine a plurality of slopes of a plurality of regression lines respectively of the plurality of first block reflection histograms; and determine the first block angle by calculating an average angle of the plurality of slopes.

In some embodiment, the processing circuit is configured to: determine a first block angle by calculating an average angle of a plurality of second block angles of a plurality of second SPAD blocks adjacent to a first SPAD block; and rotate a plurality of first block reflection histograms within the first SPAD block by the first block angle.

In some embodiment, the plurality of second SPAD blocks are adjacent to the first SPAD block.

In some embodiment, the plurality of second SPAD blocks are disposed along a vertical direction and horizontal direction of the first SPAD block, or the plurality of second SPAD blocks are disposed along diagonal directions of the first SPAD block.

In some embodiments, a direct-time-of-flight (DTOF) receiver comprises a single photon avalanche diode (SPAD) array and a processing circuit. The SPAD array comprises a plurality of SPADs arranged in rows and columns. The processing circuit is coupled to a first SPAD of the SPAD array and configured to: receive a first pixel information from the first SPAD; generate a first reflection histogram of photon count with respect to distance according to the first pixel information; rotate the first reflection histogram by a first angle; and determine a first depth according to a first peak of the rotated first reflection histogram.

In some embodiment, the processing circuit is configured to: transform the first reflection histogram using a first transformation function; and rotate the transformed first reflection histogram by the first angle.

In some embodiment, the first transform function is a logarithm function.

In some embodiment, the processing circuit is configured to calculate a first slope of a regression line within the first reflection histogram to determine the first angle.

In some embodiment, the processing circuit is configured to: determine a peak coordinate

of the first peak in the rotated first reflection histogram; reversely rotate the peak coordinate by the first angle; and determine the first depth according to a time-of-flight of the reversely-rotated peak coordinate.

In some embodiment, the processing circuit is further configured to: receive a plurality of first block pixel information from a first SPAD block of the SPAD array; generate a plurality of first block reflection histograms according to the plurality of first block pixel information; rotate the plurality of first block reflection histograms by a first block angle; and determine a plurality of first block depths according to the plurality of rotated first reflection histograms.

In some embodiment, the processing circuit is configured to: determine a plurality of slopes of a plurality of regression lines respectively of the plurality of first block reflection histograms; and determine the first block angle by calculating an average angle of the plurality of slopes.

In some embodiment, the processing circuit is configured to: determine a first block angle by calculating an average angle of a plurality of second block angles of a plurality of second SPAD blocks adjacent to a first SPAD block; and rotate a plurality of first block reflection histograms within the first SPAD block by the first block angle.

In some embodiment, the plurality of second SPAD blocks are adjacent to the first SPAD block.

In some embodiments, a processing method for generating a depth image comprises receiving a first pixel information from a first single photon avalanche diode (SPAD) of a SPAD array; generating a first reflection histogram of photon count with respect to distance according to the first pixel information; rotating the first reflection histogram by a first angle; and determining a first depth according to a first peak of the rotated first reflection histogram.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A processing circuit for generating a depth image, the processing circuit being configured to:
receive a first pixel information from a first single photon avalanche diode (SPAD) of a SPAD array;
generate a first reflection histogram of photon count with respect to distance according to the first pixel information;
rotate the first reflection histogram by a first angle; and
determine a first depth according to a first peak of the rotated first reflection histogram.

2. The processing circuit of claim 1, wherein the processing circuit is configured to:
transform the first reflection histogram using a first transformation function; and
rotate the transformed first reflection histogram by the first angle.

3. The processing circuit of claim 2, wherein the first transform function is a logarithm function.

4. The processing circuit of claim 1, wherein the processing circuit is configured to calculate a first slope of a regression line within the first reflection histogram to determine the first angle.

5. The processing circuit of claim 1, wherein the processing circuit is configured to:
determine a peak coordinate of the first peak in the rotated first reflection histogram;
reversely rotate the peak coordinate by the first angle; and
determine the first depth according to a time-of-flight of the reversely-rotated peak coordinate.

6. The processing circuit of claim 1, wherein the processing circuit is further configured to:
receive a plurality of first block pixel information from a first SPAD block of the SPAD array;
generate a plurality of first block reflection histograms according to the plurality of first block pixel information;
rotate the plurality of first block reflection histograms by a first block angle; and
determine a plurality of first block depths according to the plurality of rotated first reflection histograms.

7. The processing circuit of claim 6, wherein the processing circuit is configured to:
determine a plurality of slopes of a plurality of regression lines respectively of the plurality of first block reflection histograms; and
determine the first block angle by calculating an average angle of the plurality of slopes.

8. The processing circuit of claim 1, wherein the processing circuit is configured to:
determine a first block angle by calculating an average angle of a plurality of second block angles of a plurality of second SPAD blocks adjacent to a first SPAD block; and
rotate a plurality of first block reflection histograms within the first SPAD block by the first block angle.

9. The processing circuit of claim 1, wherein the processing circuit is configured to:
calculating an average area angle of a plurality of first block angles of a plurality of first SPAD blocks within a predetermined area; and
rotate all block reflection histograms of the plurality of first SPAD blocks by the average area angle.

10. The processing circuit of claim 8, wherein the plurality of second SPAD blocks are disposed along a vertical direction and horizontal direction of the first SPAD block, or
the plurality of second SPAD blocks are disposed along diagonal directions of the first SPAD block.

11. A direct-time-of-flight (DTOF) receiver for generating a depth image, the DTOF receiver comprising:
a single photon avalanche diode (SPAD) array comprising a plurality of SPADs arranged in rows and columns; and
a processing circuit coupled to a first SPAD of the SPAD array, the processing circuit being configured to:
receive a first pixel information from the first SPAD;
generate a first reflection histogram of photon count with respect to distance according to the first pixel information;
rotate the first reflection histogram by a first angle; and
determine a first depth according to a first peak of the rotated first reflection histogram.

12. The DTOF receiver of claim 11, wherein the processing circuit is configured to:
transform the first reflection histogram using a first transformation function; and
rotate the transformed first reflection histogram by the first angle.

13. The DTOF receiver of claim 12, wherein the first transform function is a logarithm function.

14. The DTOF receiver of claim 11, wherein the processing circuit is configured to calculate a first slope of a regression line within the first reflection histogram to determine the first angle.

15. The DTOF receiver of claim 11, wherein the processing circuit is configured to:
determine a peak coordinate of the first peak in the rotated first reflection histogram;
reversely rotate the peak coordinate by the first angle; and
determine the first depth according to a time-of-flight of the reversely-rotated peak coordinate.

16. The DTOF receiver of claim 11, wherein the processing circuit is further configured to:
receive a plurality of first block pixel information from a first SPAD block of the SPAD array;
generate a plurality of first block reflection histograms according to the plurality of first block pixel information;
rotate the plurality of first block reflection histograms by a first block angle; and
determine a plurality of first block depths according to the plurality of rotated first reflection histograms.

17. The DTOF receiver of claim 16, wherein the processing circuit is configured to:
determine a plurality of slopes of a plurality of regression lines respectively within the plurality of first block reflection histograms; and
determine the first block angle by calculating an average angle of the plurality of slopes.

18. The DTOF receiver of claim 11, wherein the processing circuit is configured to:
determine a first block angle by calculating an average angle of a plurality of second block angles of a plurality of second SPAD blocks adjacent to a first SPAD block; and
rotate a plurality of first block reflection histograms within the first SPAD block by the first block angle.

19. The DTOF receiver of claim 18, wherein the plurality of second SPAD blocks are adjacent to the first SPAD block.

20. A processing method for generating a depth image, the processing method comprising:
receive a first pixel information from a first single photon avalanche diode (SPAD) of a SPAD array;
generate a first reflection histogram of photon count with respect to distance according to the first pixel information;
rotate the first reflection histogram by a first angle; and
determine a first depth according to a first peak of the rotated first reflection histogram.
